(19) United States
(12) Patent Application Publication
(10) Pub. No.: US 2013/0111062 A1
(43) Pub. Date: May 2, 2013

(54) DETERMINATION OF A LOWEST COST PATH BETWEEN NODES

(71) Applicant: Steven Glen Jorgensen, Newcastle, CA (US)

(72) Inventor: Steven Glen Jorgensen, Newcastle, CA (US)

(21) Appl. No.: 13/285,413

(22) Filed: Oct. 31, 2011

(51) Int. Cl. G06F 15/173

(52) U.S. Cl. 709/241

(57) ABSTRACT

As described herein, a node may include storage to store a cost for each of a number of paths, where a path connects two nodes in a system. A path may be determined between the node and a destination node based on execution of a shortest path first algorithm, the shortest path first algorithm to determine if a cost between two nodes is stored in storage prior to communication with another node to determine cost.

### BACKGROUND

In a system having multiple nodes, routing protocols may be employed to route data from a source node to a destination node. In order to determine what paths are available to route data from the source node to the destination node, algorithms may be employed, for example, a shortest path first algorithm. The routing protocol may then route data in accordance with the result of the executed shortest path first algorithm.

### DRAWINGS

FIG. 1. is an example diagram of a system environment, in accordance with an example embodiment of the present disclosure.

FIG. 2 is an example local cost array, in accordance with an example embodiment of the present disclosure.

FIG. 3 is an example global cost array, in accordance with an example embodiment of the present disclosure.

FIG. 4 is an example flow diagram of a method for pre-populating a cost array, in accordance with an example embodiment of the present disclosure;

FIG. 5 is an example flow diagram of a method for determining a lowest cost path, in accordance with an example embodiment of the present disclosure.

FIG. 6 is an example flow diagram of a method for determining a lowest cost path, in accordance with an example embodiment of the present disclosure.

### DETAILED DESCRIPTION

In a system having multiple nodes, routing protocols may be employed to determine where packets are to be forwarded between nodes. Routing protocols may be based on, for example, execution of a shortest path first (SPF) algorithm. The SPF algorithm may be a recursive algorithm such that all paths from a source node to a destination node may be traversed such that the cost for each path is determined. The SPF algorithm may then identify the lowest cost from the source node to the destination node as the shortest path.

SPF algorithms are thorough, but require CPU memory and processing power to complete for very large networks. By storing costs, pre-populated and/or previously learned by earlier executed SPF algorithms, the number of iterations of the algorithm may be reduced and the performance of the algorithm can be increased.

### OVERVIEW

As discussed herein, cost information may be stored for paths between nodes in a system. The cost information may be stored, for example, locally on one or more nodes in a system, or may be stored globally where all nodes in a system may access the information.

For example, a node may locally store information related to cost of paths between itself and other nodes in a system. Alternatively, cost information may be globally stored in one table accessible by multiple nodes in the system. A given node may have multiple paths to any given destination node. These paths might traverse other nodes that are neither the source nor the destination node. The cost from the source node or nodes that are being traversed to the destination node may be pre-populated. The storage of costs may be accessed to determine if a cost to the destination node is stored. If the cost to the destination node is not stored, a SPF algorithm may be executed to identify a shortest path from the current node to the destination node having the lowest cost. If the cost is stored, then the nodes adjacent to the current node may not be queried for the cost to the destination node, as is more fully discussed below. This process may be performed on the source node and/or all intermediate nodes until either a node is reached with a populated cost or the destination node is reached.

### System Environment

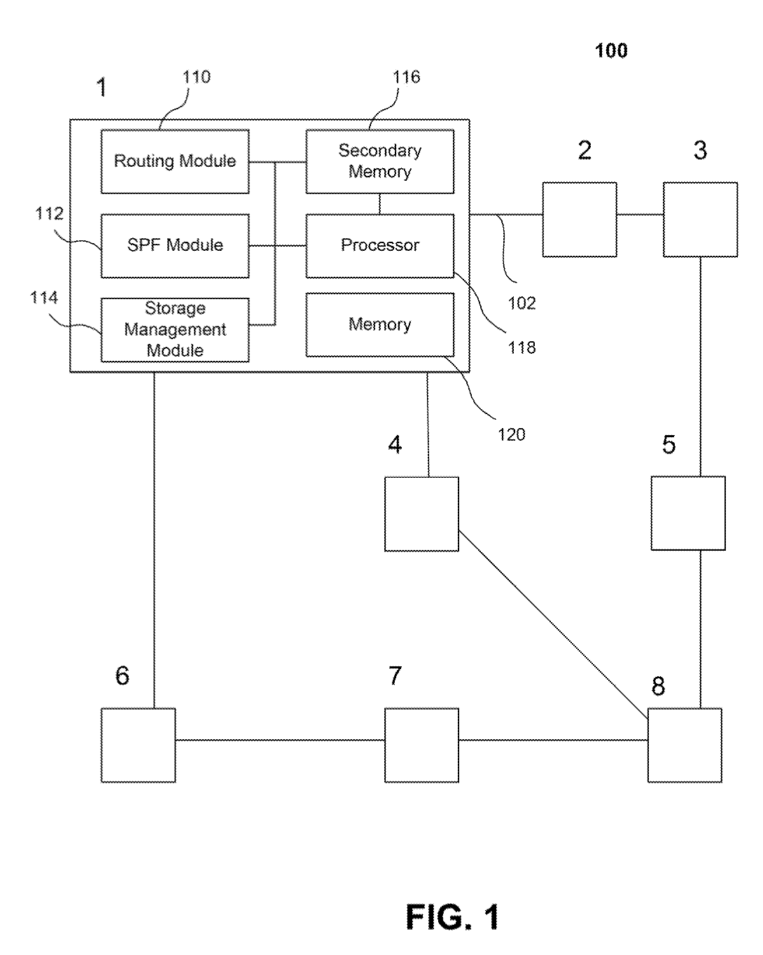

FIG. 1. depicts a diagram of a system environment 100. System environment may be implemented in, for example, in a stacked configuration where nodes are connected via one or more links. One of nodes 1-8 may be designated as a commander of the stack and is the home to all centralized software function. However, for the purposes of the discussion herein, it is not important to designate which of the nodes is the commander.

It may be appreciated that system environment may be implemented in a network where the nodes are not configured in a stack, for example, are components within the same computing device, are networked computing devices, etc.

System environment 100 includes nodes 1, 2, 3, 4, 5, 6, 7 and 8. Each of the nodes may be implemented as a networking device, for example, a switch, router, or other computing device, etc., having one or more ports. The lines between the nodes in FIG. 1 represent a link between the two nodes. A link may be, for example, a bidirectional data path on a single cable between two nodes or multiple cables that are aggregated. For example, as shown in FIG. 1, node 1 is linked to node 2 via link 102. Each link may have a cost associated with it. The cost may be an inherent property of the link based on, for example, associated bandwidth, etc. For the purposes of discussion herein, it may be assumed that each link has a cost of 1. However, it may be appreciated that the features discussed herein may apply to links having different, arbitrary, etc., costs. It may be appreciated that more or less nodes with the same or different configuration of links may be present in system environment 100. The number of nodes and the configuration of links are presented merely as an example.

All of the nodes depicted in FIG. 1, including the commander node, may be considered a member of the stack.

Nodes 1-8 may be implemented through any suitable combinations of software including machine readable instructions executable by a processor, firmware, including machine readable instructions executable by a processor and stored in one or more non-transitory computer-readable media, and/or hardware. Secondary memory may be implemented within the device and/or may be implemented as external data storage. Primary and/or secondary memory may be computer-readable mediums configurable to store modules as discussed herein. Primary and/or secondary memory may further be configurable to receive an installation pack from an external memory, for example, a portable computer-readable medium, for example, a Compact Disc/Digital Video Disc, etc.

Paths within system environment 100 may be one or more links that connect one node to another node.

A shortest path may be a path between a source node and a destination node that has the lowest cost between them.

Any node depicted in FIG. 1 may be a source node or a destination node depending on where the information to be transmitted originates and where the information is to be sent.

In addition to components to perform normal networking node functionality, node 1 includes routing module 110, SPF module 112, storage management module 114, secondary memory 116, processor 118, and memory 120. It may be appreciated that the modules shown with respect to node 1 may be included in nodes 2, 3, 4, 5, 6, 7 and 8.

Routing module 110 may route information to the destination node based on information stored in routing tables as determined shortest path by SPF module 112. SPF module 112 may refer to storage via storage management module 114 to determine if a cost is associated with a path between two nodes and, if not, execute a shortest path algorithm. Storage management module 114 may manage information stored in secondary memory 116, the information relating to costs between nodes in system environment 100. Processor 118 may execute a set of instructions, stored in a computer-readable medium, to perform the functionality associated with each of the modules discussed herein. Each of these modules is discussed more fully below.

As discussed herein, a system may be implemented as any wide area network (WAN) or local area network (LAN). For example, a system may be implemented as any wired or wireless network, including an enterprise network, wideband code division multiple access (WCDMA), personal communication services (PCS), worldwide interoperability for microwave access (WiMAX), local area network (LAN), wide area network (WAN), etc. In the example in FIG. 1, all of the nodes are configured in a stacking configuration operating in a network.

It may further be appreciated that all of the nodes in the system may be implemented as software objects within the system where the system is implemented as a software application that may be executed, by a processor, on a computing device.

### Cost Array

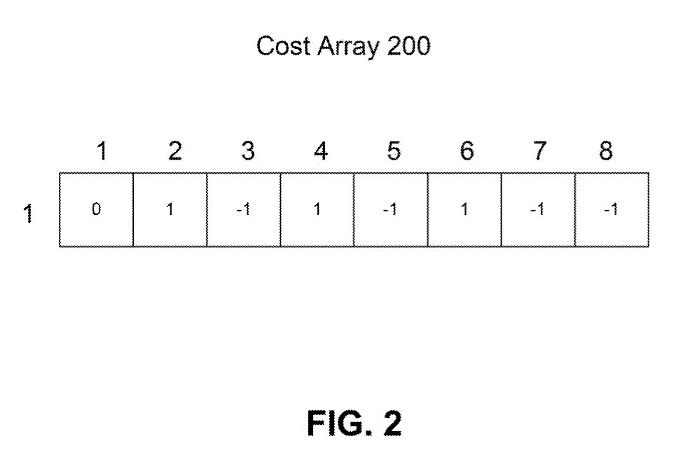

FIG. 2 depicts an example of a two-dimensional array of cost information associated with the path from node 1 to all other nodes in the system. In this example, cost array 200 is implemented as a local array that is stored, for example, in secondary memory 116 or may be stored in other memory accessible by storage management module 114 at node 1.

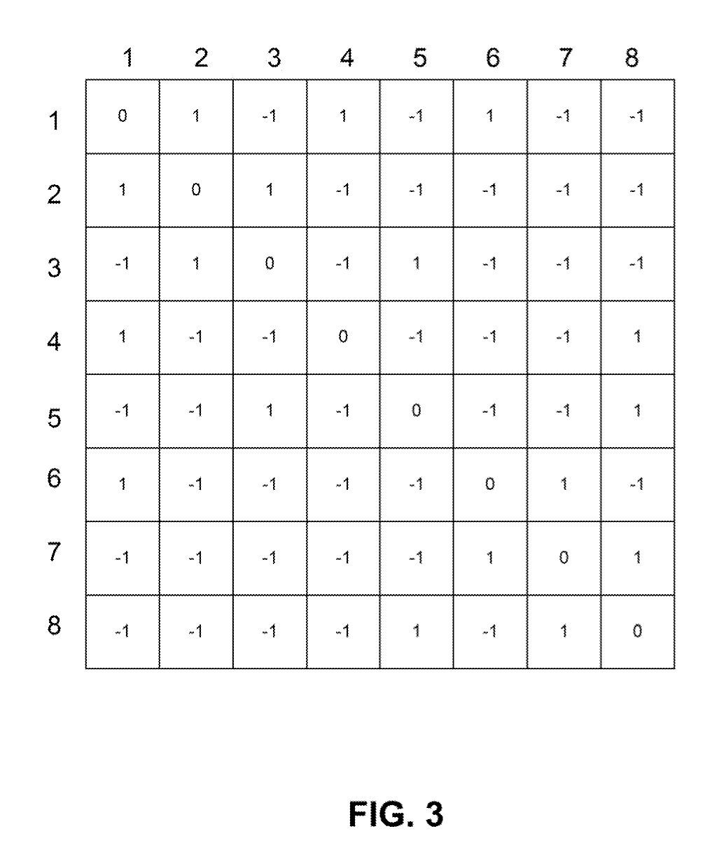

In an alternative embodiment, FIG. 3 depicts an example two-dimensional array of cost information associated with path between all nodes in the system. As shown in FIG. 3, cost array 300 includes a list of the paths between all nodes 1-8 in the system. Cost array 300 may be implemented as a global table that is accessible by all nodes in the system. Cost array 300 may be stored in memory within system 100 that is accessible by all nodes in the system.

The cost array may be pre-populated with cost information, for example, when the system is deployed. For example, when a system is deployed, information regarding direct links is determined in order to create the system. Assuming all links have a known cost, the cost array may be pre-populated with the cost of links between the adjacent nodes. For example, where the cost of all links on the system is 1, the cost array may be pre-populated with the cost of 1 for all links adjacent to the node. As shown in FIG. 2, the state of cost array 200 is where the system is deployed; the links of adjacent nodes is pre-populated with the value “1” and the SPF algorithm has not yet been executed. As such, any cost that is stored in the cost array represents a link between adjacent nodes and has a value of “1”. For nodes that are not adjacent, a predetermined value (for example, “−1”) may be added such that, when the array is queried by the storage management module 114, and a “−1” value is returned, this may represent that the cost between the two nodes is not known/stored. As shown in cost array 200, the cost associated with a path between a node and itself is “0”.

As shown in FIG. 3, the example global table is pre-populated with the cost of 1 for all adjacent nodes. The state of cost array 300 is where the system is deployed; the links of adjacent nodes for each node in system 100 is pre-populated with the value “1” and the SPF algorithm has not yet been executed. As such, any cost that is stored in the cost array represents a link between adjacent nodes and has a value of “1”. For nodes that are not adjacent, a predetermined value (for example, “−1”) may be added such that, when the array is queried by the storage management module 114, and a “−1” value is returned, this may represent that the cost between the two nodes is not known/stored. As shown in cost array 200, the cost associated with a path between a node and itself is “0”.

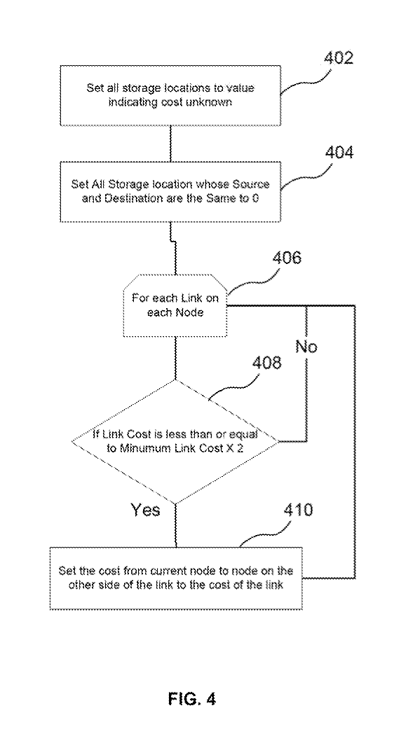

FIG. 4 depicts an example of a flow diagram that may be implemented in system 100 to pre-populate a global table. In this example, it is presumed that the cost of all links in the system is “1”. As shown in FIG. 4, the array is created based on the number of nodes in the system. As there are 8 nodes in the system, in this example, the array is 8×8. All storage locations are set to a value indicating that the cost between the nodes is unknown, for example, “−1” (402). For all locations where the source node and the destination node are the same, the value of “0” is entered, as the cost between a node and itself is “0” (404). For each link on each node (406), it is determined if link cost is less than or equal to a minimum cost link cost ×2 (408). The minimum cost link may be a minimum value that is predefined for all links in system 100.

If the cost is equal to one (408, Yes), then the nodes are adjacent links and the cost from the current node to the node on the other side of the link (the adjacent node) is set at “1” in the cost array (410). If the cost is not equal to “1”, then processing proceeds to 406, where the next link is selected as the current node. After the algorithm is complete, the cost array 300 is fully pre-populated.

As noted above, in one embodiment, the cost of each of the links in the system may be arbitrary. In this case, the system may have a predefined minimum weight for all links in the system. If the cost of the link is less than or equal to 2 times the minimum cost of any link, then the link is determined to be a link to an adjacent node and the table may be pre-populated with the cost of the link.

In other words, for each link on each node of a plurality of nodes, it may be determined if a cost between a node and a node on the other side of the link is less than or equal to a minimum link cost ×2. If the cost is less than or equal to a minimum link cost ×2, a storage location associated with the path between the node and the node on the other side of the link may be updated with the determined cost.

Alternatively, if paths are symmetric, the paths for the reverse path may be updated. A path may be symmetric if the cost of the link is the same in both directions, i.e., from the source node to the destination node and the path from the destination node to the source node. In some systems, it may be presumed that the paths are symmetrical. Alternatively, there may be an additional calculation to determine if the path from the destination node to the source node is symmetrical. If it is determined that the path is symmetrical, then the storage management module may update the cost array with the cost from the source node to the destination node with the same cost from the destination node to the source node.

### Storage Management Module

Storage management module 114 may create, add, modify and delete information stored in cost array 200, cost array 300, etc.

Storage management module 114 may create cost array 200, cost array 300, etc., in storage based on the number of nodes in the system. Storage management module may pre-populate the cost array 200, cost array 300, etc., with the cost for the paths between adjacent nodes using the cost for links between the nodes as noted above with regard to FIG. 4.

As new lowest costs are learned, storage management module 114 may update the cost array 200 with the new costs.

### SPF Module

SPF module 112 may determine a lowest cost path between a source node and a destination node by executing an algorithm that may include execution of an SPF algorithm. It may be appreciated that the SPF algorithm may employ, in addition to the functionality discussed herein, an open shortest path first algorithm, a recursive open shortest path first algorithm, etc.

Prior to executing an SPF algorithm, the SPF module 112 may query storage management module 114 to determine if the cost from the source node to the destination node is stored. If the cost is stored, then the SFP algorithm is not executed. This is because only the lowest cost between two nodes is stored in the cost array 200, cost array 300, etc. If the cost is not stored, then a SPF algorithm may be executed as follows.

In executing a SPF algorithm, the source node will consider the cost of each path through all of the node's links to the destination node. To determine the cost of getting to the destination through a link, the cost of the link to its adjacent node is added to the cost of getting from the node on the other side of the link to the destination node. That cost may be stored in the storage management module or the SPF algorithm will query all of the node's (current node) links. Once the cost is determined for all of the node's links, the SPF module may select the path that has the lowest cost. The lowest cost may be forwarded to the storage management module and stored in cost array 200.

By updating the local cost array 200, global cost array 300, etc., with the determined cost for the shortest path between the source node and the destination node, if the source node is an intermediate node from another source to the same destination, the path does not need to be re-calculated because the cost is already known.

The following represents an example implementation of a portion of the SPF module. In the following example, cost and weight are interchangeable. Node and member are interchangeable.

```
//////Functions to calculate Constrained Weighted Open Shortest Path First
//This array stores pre-calculated Cost from Member A to Member B. This can be
//checked during the recursive function to prevent calculation of a cost that
//has already been calculated. If the value is −1 then the cost has not been
//calculated. It can be pre-populated with all the single hop costs which do
//not require recursion.
extern pathCostArray[MAX_STACK_MEMBERS][MAX_STACK_MEMBERS]: int;
initPathCostArray( ) {
    for each stackNum less than MAX_STACK_MEMBERS {
        for each portNum less than MAX_STACK_PORTS {
            memberB = getNextMember(stackNum,portNum);
            if (checkLinkValid(stackNum,portNum) &&
        (getRoutingHints(stackNum,portNum)
in [ANY_CONNECTION, SHORT_CUT])) {
                pathCostArray[StackNum][memberB] =
                stackLinkWeights[stackNum][portNum];
            }
            else {
                pathCostArray[StackNum][memberB] = −1;
            }
        }
    }
}
//////Functions to calculate cost between two Members.
//returns a −1 if no path was found
findOpenShortestPathFirst(currentMember,ingressPort,srcMember,dstMember,isChain
WithShortcuts,*previousMemberList) : int {
    localCost = MAX_STACK_MEMBER * DEFAULT_LINK_WEIGHT;
    localLinkCost : int = 0;
    if (pathCostArray[currentMember][dstMember] >= 0) {
        return pathCostArray[currentMember][dstMember];
    }
    else if (currentMember == dstMember) {
        //should not get here is pathCostArray is set correctly
        return 0;
    }
    else if (currentMember is in previousMemberList) {
        return −1;
    }
    else {
        bestLink = −1;
        for each portNum less than MAX_STACK_PORTS {
            if (portNum != ingressPort) {
                if (checkLinkValid(currentMember,portNum) &&
(getRoutingHints(currentMember,portNum) == ANY_CONNECTION)) {
                    nextMember =
                    getNextMember(currentMember,portNum);
                    nextPort =
                    getNextMemberLink(currentMember,portNum);
                    previousMemberList[size(previousMemberList)] =
                    currentMember;
                    tmpCost =
findOpenShortestPathFirst(nextMember,nextPort,srcMember,dstMember,isChainWith
Shortcuts,*previousMemberList)
                    tmpLinkCost =
                    stackLinkWeights[currentMember][portNum];
                    if ((tmpCost > 0) && ((tmpCost + tmpLinkCost) <
                    localCost)) {
                        bestLink = portNum;
                        localCost = tmpCost + tmpLinkCost;
                    }
                }
            }
        }
        if (bestLink < 0) {
            return −1;
        }
        else {
            pathCostArray[currentMember][dstMember] = (localCost +
            localLinkCost);
            return localCost;
        }
    }
}
```

### Example

Referring to FIG. 1, assume for this example that node 1 is the source node and node 8 is the destination node and the link with the lowest cost to node 8 needs to be determined. Further assume that local cost array 200 is employed. SPF module 112 may query storage management module 114 for a value associated with the path between node 1 and node 8. Storage management module 114 returns the stored value “−1”. Value “−1” indicates that the cost for this path is not known.

SPF module 112 begins execution of a SPF algorithm by traversing all of the nodes linked with node 1, namely nodes 2, 4 and 6. Starting with node 2, SPF module 112 may transmit a query to node 2 for a cost between node 2 and node 8.

When the request is received at node 2, SPF module at node 2 may query storage management module at node 2 for a value associated with the path between node 2 and node 8. Storage management module, for example, returns the stored value “3”, where the cost array at node 2 is populated. Value “3” indicates that the lowest cost for this path is known. This value is returned to node 1. The cost to get from 1 to 8 via this link is 4. This value may be transmitted to the storage management module 114 for temporary storage until the cost through each of the links is determined.

SPF module 112 continues execution of the SPF algorithm by traversing the next node linked with node 1, namely node 4. Thus, a query is transmitted to node 4 for a cost between node 4 and node 8.

When the request is received at node 4, SPF module at node 4 may query storage management module at node 4 for a value associated with the path between node 4 and node 8. Storage management module, for example, returns the stored value “1” where the cost array at node 4 is pre-populated with a value “1”, because nodes 4 and 8 are adjacent. Value “1” indicates that the lowest cost for this path is known. This value is returned to node 1. The cost to get from 1 to 8 via this link is 2. This value may be transmitted to the storage management module 114 for temporary storage until the cost through each of the links is determined.

SPF module 112 continues execution of the SPF algorithm by traversing the next node linked with node 1, namely node 6. SPF module 112 may transmit a query to node 6 for a cost between node 6 and node 8.

When the request is received at node 6, SPF module at node 6 may query storage management module at node 6 for a value associated with the path between node 6 and node 8. Storage management module, for example, returns the stored value “−1”. Value “−1” indicates that the lowest cost for this path is not known. Thus, the SPF module at node 6 executes a SPF algorithm to determine the lowest cost path between node 6 and 8.

SPF module at node 6 begins execution of a SPF algorithm by traversing all of the nodes linked with node 6, namely node 7. Node 6 will not traverse the link that the query came in on. A query is transmitted to node 7 for a cost between node 7 and node 8.

When the request is received at node 7, SPF module at node 7 may query storage management module at node 7 for a value associated with the path between node 7 and node 8. Storage management module, for example, returns the stored value “1”. Value “1” indicates that the lowest cost for this path is known. This value is returned to node 6. Node 7 returns the cost of 1 to node 6 which returns the cost of 2 to node 1, and the cost to get to node 8 via that link is 3. This value may be transmitted to the storage management module 114 for temporary storage.

Once all of the path costs to get to node 8 through each of the links at node 1 have been determined, the SPF module 112 selects the lowest cost path (in this example, cost =2 through node 4) and transmits the lowest cost value to the storage management module 114. The storage management module associates the value with the path between the source node and the destination node and stores the value in the cost array 200.

Alternatively, the algorithm may be implemented such that a temporary lowest cost is stored. Each time a cost is received at storage management module for a path through one of the node's links, the cost through the current node is compared with the temporary lowest cost. If the cost through the current node is lower than the temporary lowest cost, then the temporary lowest cost is updated with the cost through the current node. If the cost through the current node is greater than the temporary lowest cost, then the temporary lowest cost is not updated with the cost through the current node.

### System Flow

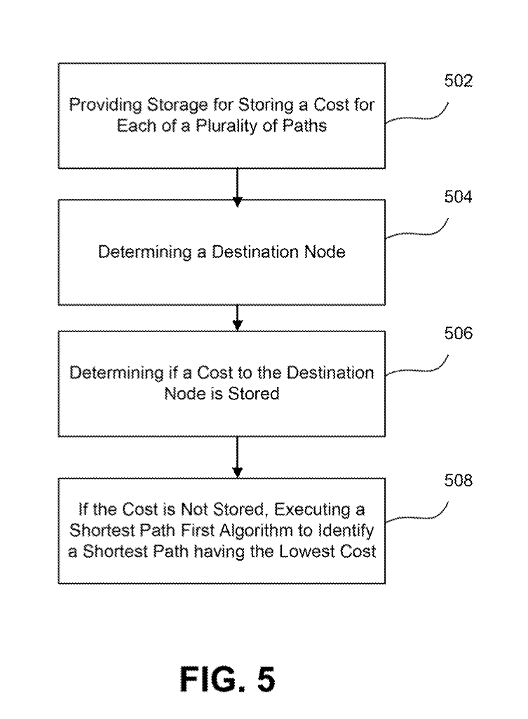

FIG. 5 depicts an example flow diagram of the steps performed in determining a lowest cost path from a source node to a destination node. As shown in FIG. 5, storage is provided for storing a cost for each of a plurality of paths. Each of the plurality of paths connects two nodes in a system. The cost for at least one path is pre-populated (502).

When the configuration depicted in FIG. 1 is deployed, all links between two nodes are known. Assuming the cost for each link is “1”, the cost associated with those paths, i.e., the paths between two nodes that are directly connected, or linked, is pre-populated with the value “1”.

A destination node is determined for information that is to be transmitted (504).

It is determined if a cost from the source node to the destination node is stored (506).

If the cost from the source node to the destination node is not stored, a SPF algorithm is executed to identify a shortest path from the source node to the destination node having the lowest cost (508).

In executing the SPF algorithm, it may be determining if a cost for a path between a linked node to the destination node is stored. If the cost for the path between the linked node to the destination node is stored, the SPF module may identify the stored cost as the lowest cost for the path between the linked node and the destination node. After determining the cost to the destination node through all of nodes linked to the source node, the lowest cost path may be determined. The information may be routed to the destination node based on the determined lowest cost path.

Alternatively, the costs that are stored in the cost array 200, cost array 300, etc., may be considered states of the lowest cost path between two nodes. Thus, when the SPF module 112 is determining the lowest cost path, and referring to the cost array 200, cost array 300, etc., the costs that are stored may be considered previous states of the shortest paths that have previously been determined. Information may be routed from a source node to a destination node based on the determined lowest cost path.

It may be appreciated that once a lowest cost for a path is determined between two nodes, one or more routing tables may be updated within system environment 100 (not shown) to reflect the link to the node having the lowest cost.

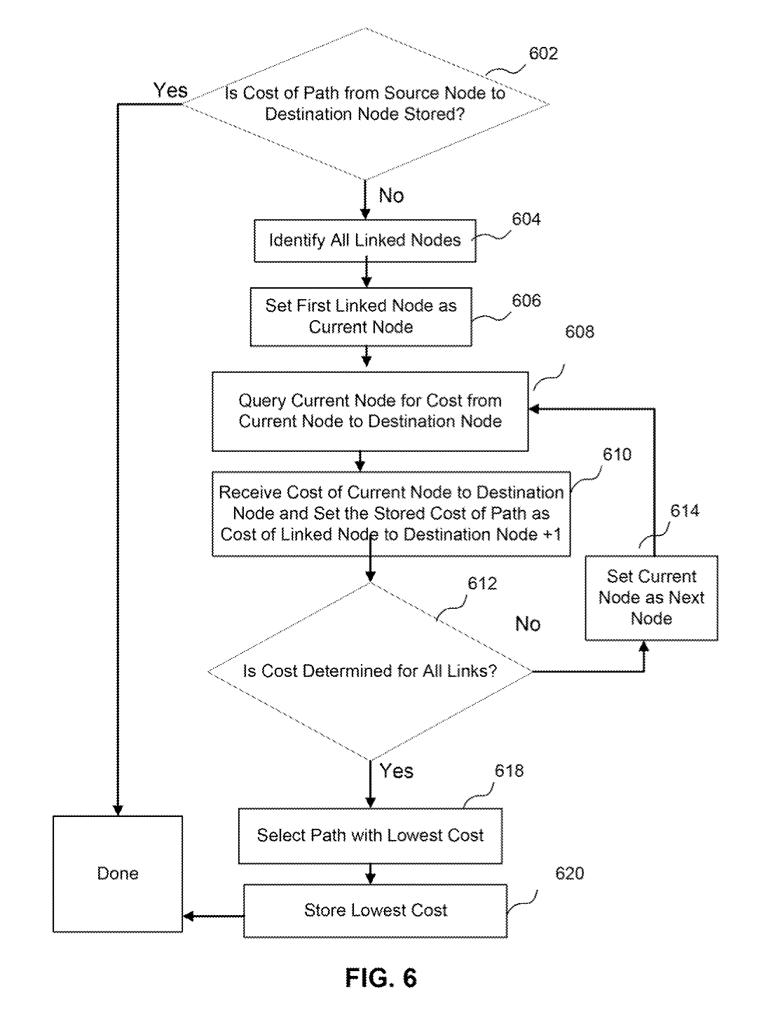

FIG. 6 depicts an example flow diagram of a method for identifying a lowest cost path, in accordance with an example embodiment of the present disclosure. The process shown in FIG. 6 may be performed by SPF module 112 in conjunction with one or more modules at the source node.

When a destination node is determined, a determination is made as to whether the cost of the path from the source node to the destination node is stored (602). If the cost of the path between the source node and destination node is stored (602, Yes), then processing is complete.

If the cost is not stored (602, No), then all nodes linked to the source node are identified (604). The first linked node is set as the current node (606). The source node then queries the current node for the cost from the current node to the destination node (608). The source node then receives a response to the query, the response including the cost from the current linked node to the destination node and the source node determines the cost from the source node to the destination node via the current linked node is the cost received in the response from the query, plus 1 (the cost from the source node to the current linked node) (610).

The source node determines if the cost has been determined for all links of adjacent nodes of the source node (612). If the cost has not been determined for all links (612, No), then the current node is set as the next linked node (614) and processing returned to 608. If the cost has been determined for all links (612, Yes), then the source node selects the path through the link with the lowest cost (618). The lowest cost is then stored in the cost array 200 (620).

It may be appreciated that when the query is sent to the linked node for the cost from the linked node to the destination node (608), the linked node may perform the process shown in FIG. 6 to determine the lowest cost path between the linked (current) node and the destination node.

Any node in system environment that is queried to identify the path from the node to the destination node may perform the process shown in FIG. 6 to determine the lowest cost path between the linked node and the destination node.

I claim:

1. A method, comprising:
providing, at a source node, storage for storing a cost for each of a plurality of paths, each of the plurality of paths connecting two nodes, the cost for at least one path being pre-populated;
determining a destination node for information to be transmitted from the source node;
determining if a cost to the destination node is stored; and
if the cost to the destination node is not stored, executing a shortest path first algorithm to identify a shortest path from the source node to the destination node having the lowest cost.

2. The method of claim 1, further comprising:
associating the identified lowest cost with the path between the source node and the destination node; and
storing the identified cost in storage.

3. The method of claim 1, wherein execution of the shortest path first algorithm includes
determining all paths from the source node to the destination node; and
selecting the path from the source node to the destination node that has the lowest cost.

4. The method of claim 2, further comprising:
routing information to the destination node based on the lowest cost path between the source node and the destination node.

5. The method of claim 1, further comprising:
pre-populating in storage the cost associated with all paths representing a direct link between the source node and other nodes.

6. The method of claim 1, wherein executing the shortest path first algorithm includes:
determining if a cost for a path between a linked node to the destination node is stored; and
if the cost for the path between the linked node to the destination node is stored, identifying the stored cost as the lowest cost for the path between the linked node and the destination node.

7. A node, comprising:
storage to store a cost for each of a plurality of paths, each of the plurality of paths connecting two nodes in a system, the cost for at least one path being pre-populated; and
a path selection module to determine a path between the node and a destination node based on execution of a shortest path first algorithm, the shortest path first algorithm to determine if a cost between two nodes is stored in storage prior to communication with another node to determine cost.

8. The node of claim 7, further comprising:
a routing module to route information from the node to the destination node based on the determined path by the path selection module.

9. The node of claim 7, further comprising:
a storage management module to determine if a cost is stored for a path between the source node and the destination node.

10. The node of claim 7, wherein the path selection module is to determine a cost of the path determined by the path selection module; and
a storage management module to associate the determined cost with the path between the node and the destination node and store the determined cost in storage.

11. The node of claim 9, wherein the storage management module further is to:
determine if the path from the source node to the destination node and the path from the destination node to the source node is symmetric; and
if paths are symmetric, associate the determined cost with the path from the destination node to the source node and store the determined cost in storage.

12. A non-transitory computer readable medium to store a set of instructions that, when executed by a processor, perform a method to:
for each link on each node of a plurality of nodes, determine if a cost between a node and a node on the other side of the link is less than or equal to a minimum link cost ×2; and
if the cost is less than or equal to a minimum link cost ×2, updating a storage location with the determined cost. The non-transitory computer readable medium of claim 12, wherein when the determined cost less than or equal to a minimum link cost ×2, the node on the other side of the link is an adjacent node.

13. The non-transitory computer-readable medium of claim 11, the method further to:
determine a destination node for information to be transmitted from the source node;
determine if a cost to the destination node is stored; and
if the cost to the destination node is not stored, executing a shortest path first algorithm to identify a shortest path from the source node to the destination node having the lowest cost.

14. The non-transitory computer-readable medium of claim 13, the method further to:
determine if the path from the source node to the destination node and the path from the destination node to the source node is symmetric; and
if paths are symmetric, associate the determined cost with the path from the destination node to the source node and store the determined cost in storage.

15. The non-transitory computer readable medium of claim 13, the method further to:
associate the determined cost with the path from the source node to the destination node; and
store the determined cost in storage.
